(19) United States
(12) Patent Application Publication
(10) Pub. No.: US 2026/0369855 A1
(43) Pub. Date: Nov. 19, 2026

(54) CIRCUIT STRUCTURE FOR SUPPRESSING ELECTROMAGNETIC NOISE

(71) Applicant: EMPASS TECHNOLOGY INC., New Taipei (TW)

(72) Inventors: Yang-Chih HUANG, New Taipei (TW); Chi-Kai SHEN, New Taipei (TW); Yu-Hao CHENG, New Taipei (TW)

(73) Assignee: EMPASS TECHNOLOGY INC., New Taipei (TW)

(21) Appl. No.: 19/674,155

(22) Filed: May 12, 2026

(30) Foreign Application Priority Data
May 16, 2025 (TW) 114118484

(51) Int. Cl. H01P 1/20; H01F 27/28; H01P 3/08

(52) U.S. Cl. CPC H01P 1/20; H01F 27/28; H01P 3/08

(57) ABSTRACT

A circuit structure for suppressing electromagnetic noise is disclosed. The circuit structure includes a substrate, a transformer, and a common-mode filtering circuit. The substrate includes a first conductor, a second conductor, and a third conductor, and the first conductor, the second conductor, and the third conductor form the common-mode filtering circuit. The transformer is disposed on the substrate and is electrically connected to the first conductor and the second conductor. The first conductor carries a positive signal of a differential signal, and the second conductor carries a negative signal of the differential signal. The third conductor is electromagnetically coupled to the first conductor and the second conductor. By improving the circuit structure, package volume can be reduced, space utilization can be improved, and process stability and yield can be enhanced.

### CROSS-REFERENCE TO RELATED APPLICATION

This non-provisional application claims priority under 35 U.S.C. § 119(a) to Patent Application No. 114118484 filed in Taiwan, R.O.C. on May 16, 2025, the entire contents of which are hereby incorporated by reference.

### BACKGROUND

### Technical Field

The present disclosure relates to noise suppression technology applied to network communication, and more particularly to a circuit structure for suppressing electromagnetic noise.

### Related Art

In order to ensure reliable transmission of network signals, a transformer and a common-mode filtering circuit are typically disposed between a network interface and a network chip to suppress electromagnetic noise in signals transmitted therebetween.

In conventional implementations, the common-mode filtering circuit is often realized by a common-mode choke, and the transformer and the common-mode choke are frequently integrated within a package housing. The transformer and the common-mode choke may be mounted on a substrate within the network interface or on a substrate including the network chip through terminals provided on the package housing. Such packaging arrangements may occupy a relatively large area on the substrate, thereby affecting space utilization and posing challenges for equipment miniaturization.

In addition, certain conventional configurations employ multiple transformers and multiple common-mode chokes. Each transformer and common-mode choke may require a separate magnetic core and winding, and these components may be interconnected and integrated within a single package. In some cases, improving performance and/or manufacturing yield may involve increasing the number of magnetic cores and windings, which may lead to higher manufacturing costs and increased package volume.

Accordingly, there remains a need for an improved circuit structure for suppressing electromagnetic noise.

### SUMMARY

In view of the foregoing, one primary objective of the present disclosure is to provide a circuit structure for suppressing electromagnetic noise. The circuit structure integrates a common-mode filtering circuit into a substrate so as to reduce package volume, improve manufacturing processes, and enhance substrate space utilization, wherein the common-mode filtering circuit is realized by conductor patterns formed in the substrate rather than by using a magnetic core or embedding magnetic material therein.

To achieve the above objective, according to one aspect of the present disclosure, the circuit structure for suppressing electromagnetic noise comprises:
a substrate including a first conductor, a second conductor, a third conductor, and a reference potential node, wherein the first conductor, the second conductor, and the third conductor form a common-mode filtering circuit; and
a transformer disposed on the substrate and electrically connected to the first conductor and the second conductor;
wherein the first conductor carries a positive signal of a differential signal and the second conductor carries a negative signal of the differential signal;
wherein the third conductor is electromagnetically coupled to the first conductor and the second conductor and is electrically connected to the reference potential node to form a resonant circuit structure.

Through the above structure, the first conductor, the second conductor, and the third conductor of the substrate form the common-mode filtering circuit. The first conductor and the second conductor are electrically connected to the transformer to respectively carry the positive signal and the negative signal of the differential signal. The third conductor is electromagnetically coupled to the first conductor and the second conductor and forms the resonant circuit structure with the reference potential node. By implementing the common-mode filtering circuit on the substrate to replace a conventional common-mode choke, the number of magnetic cores and windings required in the transformer and the common-mode filtering circuit may be reduced, thereby reducing package volume, improving substrate space utilization, and enhancing process stability and yield.

According to another aspect of the present disclosure, the circuit structure for suppressing electromagnetic noise comprises:
a substrate including a first conductor and a second conductor, the first conductor and the second conductor forming a common-mode filtering circuit; and
a transformer disposed on the substrate and electrically connected to the first conductor and the second conductor;
wherein the first conductor carries a positive signal of a differential signal and the second conductor carries a negative signal of the differential signal;
wherein when a common-mode noise is introduced into the first conductor and the second conductor, a magnetic coupling coefficient between the first conductor and the second conductor is greater than 0.3 such that a resonant circuit structure is formed.

Through the above structure, the first conductor and the second conductor of the substrate form the common-mode filtering circuit and are electrically connected to the transformer to respectively carry the positive signal and the negative signal of the differential signal. When the common-mode noise is introduced into the first conductor and the second conductor, the magnetic coupling coefficient between the first conductor and the second conductor is greater than 0.3 so that the resonant circuit structure is formed. By implementing the common-mode filtering circuit on the substrate to replace a conventional common-mode choke, the number of magnetic cores and windings required in the transformer and the common-mode filtering circuit may be reduced, thereby reducing package volume, improving substrate space utilization, and enhancing process stability and yield.

### BRIEF DESCRIPTION OF THE DRAWINGS

FIG. 1 is a schematic circuit diagram of a circuit structure according to a first embodiment of the present disclosure;

FIG. 2 is a schematic structural diagram of the circuit structure according to the first embodiment of the present disclosure;

FIG. 2A is a schematic circuit diagram of a transformer of the circuit structure according to the first embodiment of the present disclosure;

FIG. 3 is a schematic side view of a substrate of the circuit structure according to the first embodiment of the present disclosure;

FIG. 3A is a schematic common-mode equivalent half-circuit diagram of a resonant circuit structure of the circuit structure according to the first embodiment of the present disclosure;

FIG. 4A is another schematic circuit diagram of the circuit structure according to the first embodiment of the present disclosure;

FIG. 4B is yet another schematic circuit diagram of the circuit structure according to the first embodiment of the present disclosure;

FIG. 4C is still another schematic circuit diagram of the circuit structure according to the first embodiment of the present disclosure;

FIG. 5 is a schematic structural diagram of a circuit structure according to a second embodiment of the present disclosure;

FIG. 6 is a schematic side view of a substrate of the circuit structure according to the second embodiment of the present disclosure;

FIG. 7 is a schematic structural diagram of a circuit structure according to a third embodiment of the present disclosure;

FIG. 8 is a schematic side view of a substrate of the circuit structure according to the third embodiment of the present disclosure;

FIG. 9 is a schematic structural diagram of a circuit structure according to a fourth embodiment of the present disclosure;

FIG. 10 is a schematic side view of a substrate of the circuit structure according to the fourth embodiment of the present disclosure;

FIG. 11 is a schematic structural diagram of a circuit structure according to a fifth embodiment of the present disclosure;

FIG. 12 is a schematic side view of a substrate of the circuit structure according to the fifth embodiment of the present disclosure;

FIG. 13 is a schematic structural diagram of a substrate of a circuit structure according to a sixth embodiment of the present disclosure;

FIG. 14 is a schematic structural diagram of a substrate of a circuit structure according to a seventh embodiment of the present disclosure;

FIG. 15 is a schematic circuit diagram of a circuit structure according to an eighth embodiment of the present disclosure;

FIG. 16 is a schematic circuit diagram of a circuit structure according to a ninth embodiment of the present disclosure;

FIG. 17A is a schematic structural diagram of a substrate of a circuit structure according to a tenth embodiment of the present disclosure;

FIG. 17B is a schematic common-mode equivalent half-circuit diagram of a resonant circuit structure according to the tenth embodiment of the present disclosure;

FIG. 18A is a schematic structural diagram of a substrate of a circuit structure according to an eleventh embodiment of the present disclosure;

FIG. 18B is a schematic structural diagram of a substrate of a circuit structure according to the eleventh embodiment of the present disclosure; and

FIG. 18C is a schematic structural diagram of a substrate of a circuit structure according to the eleventh embodiment of the present disclosure.

### DESCRIPTION OF THE PREFERRED EMBODIMENTS

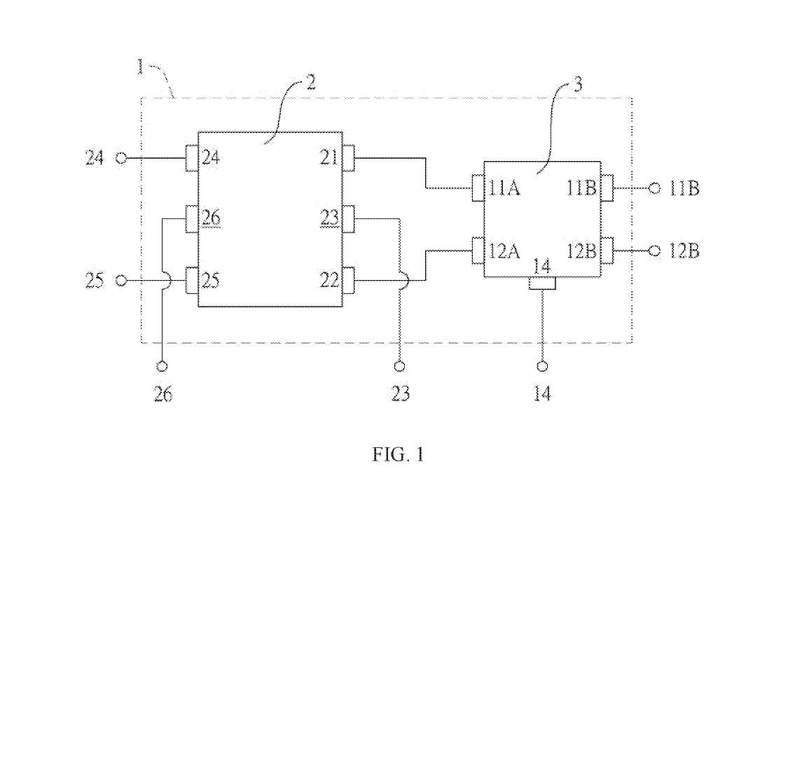

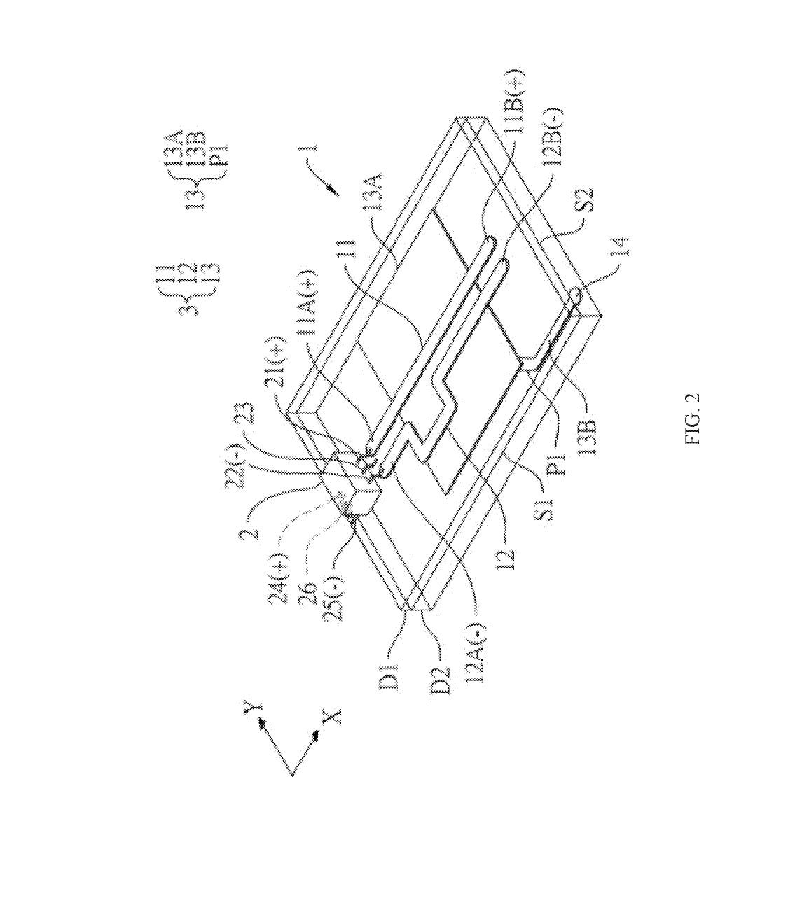

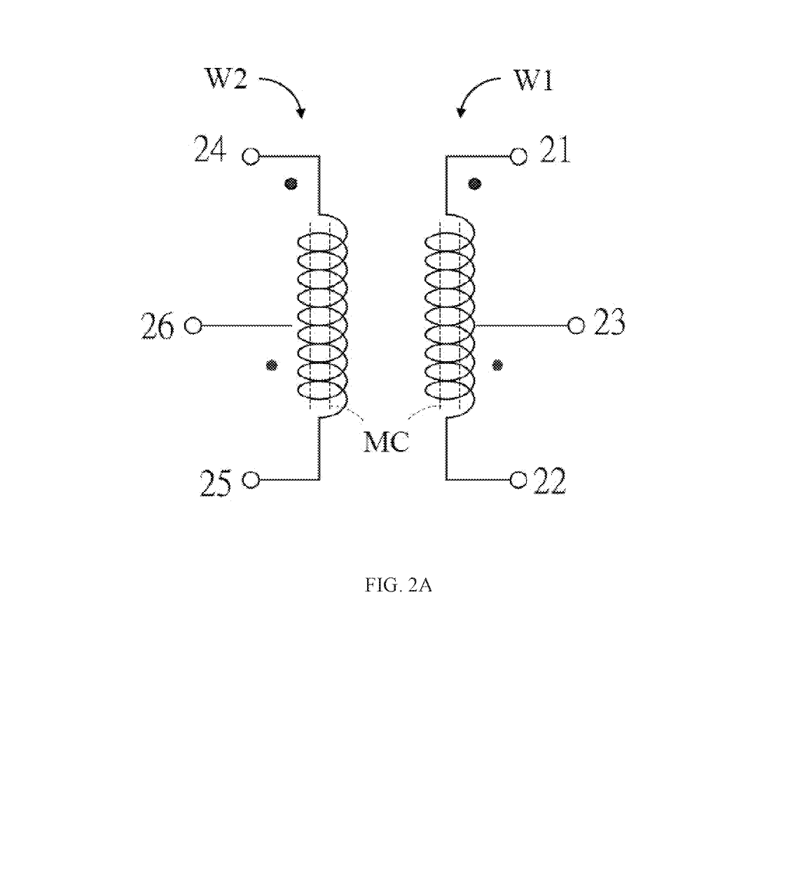

Referring to FIGS. 1 and 2, a first embodiment of a circuit structure for suppressing electromagnetic noise of the present disclosure includes a substrate 1 having a plurality of metal layers, a transformer 2, and a common-mode filtering circuit 3. The transformer 2 is disposed on the substrate 1 and is electrically connected to the common-mode filtering circuit 3. In this embodiment, the substrate 1 includes a strip-shaped first conductor 11, a strip-shaped second conductor 12, a third conductor 13, a reference potential node 14, a first dielectric layer D1, and a second dielectric layer D2. The third conductor 13 includes a first segment 13A in a rectangular planar form, a first conductive via P1, and a strip-shaped second segment 13B. The substrate 1 is rectangular and has a first side edge S1 and a second side edge S2, and the first conductor 11, the second conductor 12, and the third conductor 13 form the common-mode filtering circuit 3.

In this embodiment, the first dielectric layer D1 is located on the second dielectric layer D2. The first conductor 11, the second conductor 12, and the third conductor 13 are respectively formed by metal layers within the substrate 1, and the first conductor 11, the second conductor 12, the third conductor 13, and the reference potential node 14 are arranged in different layers between the first dielectric layer D1 and the second dielectric layer D2. As shown in FIG. 2A, the transformer 2 is implemented by winding a first winding W1 and a second winding W2 on a magnetic core MC made of a high-permeability magnetic material. The first winding W1 includes a first pin 21, a second pin 22, and a first center tap 23, and the second winding W2 includes a third pin 24, a fourth pin 25, and a second center tap 26. In this embodiment, the first pin 21 carries a positive signal (+) of a differential signal, the second pin 22 carries a negative signal (−) of the differential signal, and the third pin 24 and the fourth pin 25 respectively carry the positive signal (+) and the negative signal (−) of the differential signal.

The first conductor 11 and the second conductor 12 are respectively electrically connected to the first pin 21 and the second pin 22 to respectively carry the positive signal (+) and the negative signal (−) of the differential signal. The first segment 13A of the third conductor 13 is electromagnetically coupled to the first conductor 11 and the second conductor 12. The second segment 13B of the third conductor 13 is electrically connected to the reference potential node 14 to form a resonant circuit structure. In this embodiment, the substrate 1 may be a printed circuit board or a ceramic substrate. In this embodiment, “electromagnetic coupling” refers to an electrically indirect connection between components, and “electrical connection” refers to an electrically direct connection between components.

Through the first conductor 11, the second conductor 12, and the third conductor 13 of the substrate 1, the common-mode filtering circuit 3 is formed. The first conductor 11 and the second conductor 12 are electrically connected to the first pin 21 and the second pin 22 of the transformer 2 to respectively carry the positive signal (+) and the negative signal (−) of the differential signal. The third conductor 13 is electromagnetically coupled to the first conductor 11 and the second conductor 12 and forms the resonant circuit structure with the reference potential node 14 so as to suppress propagation of common-mode noise carried by the first conductor 11 and the second conductor 12. By improving the circuit structure of the present disclosure, the common-mode filtering circuit is implemented on the substrate to replace a conventional common-mode choke, thereby reducing the number of magnetic cores and windings required in the transformer and the common-mode filtering circuit, achieving reduced package volume and improved substrate space utilization, and enhancing process stability and yield.

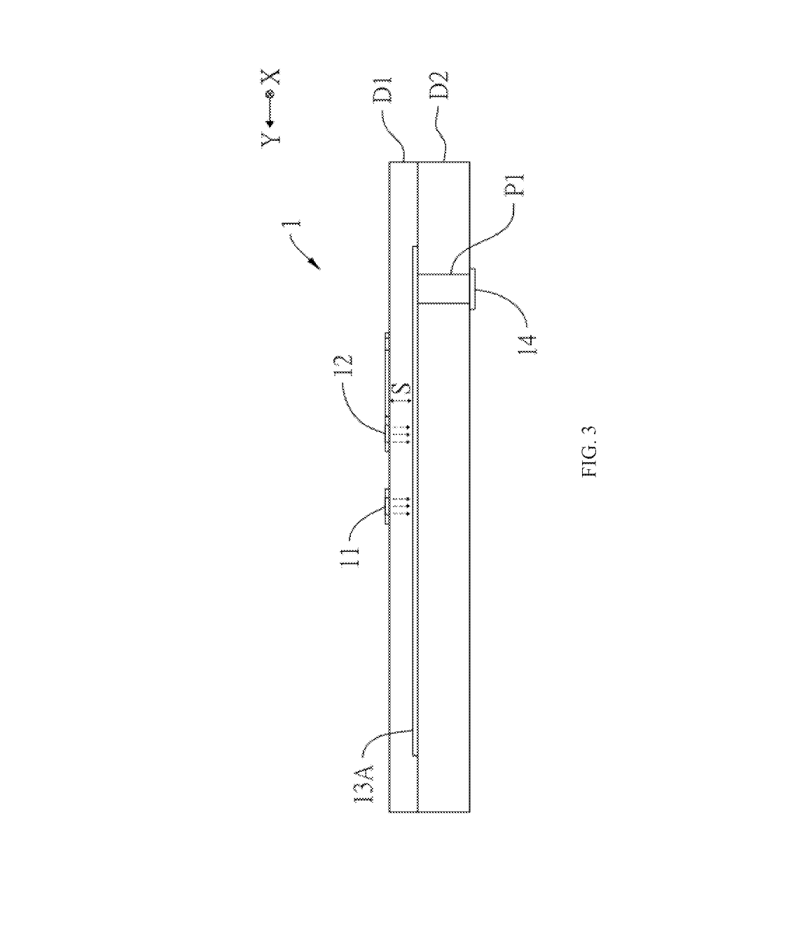

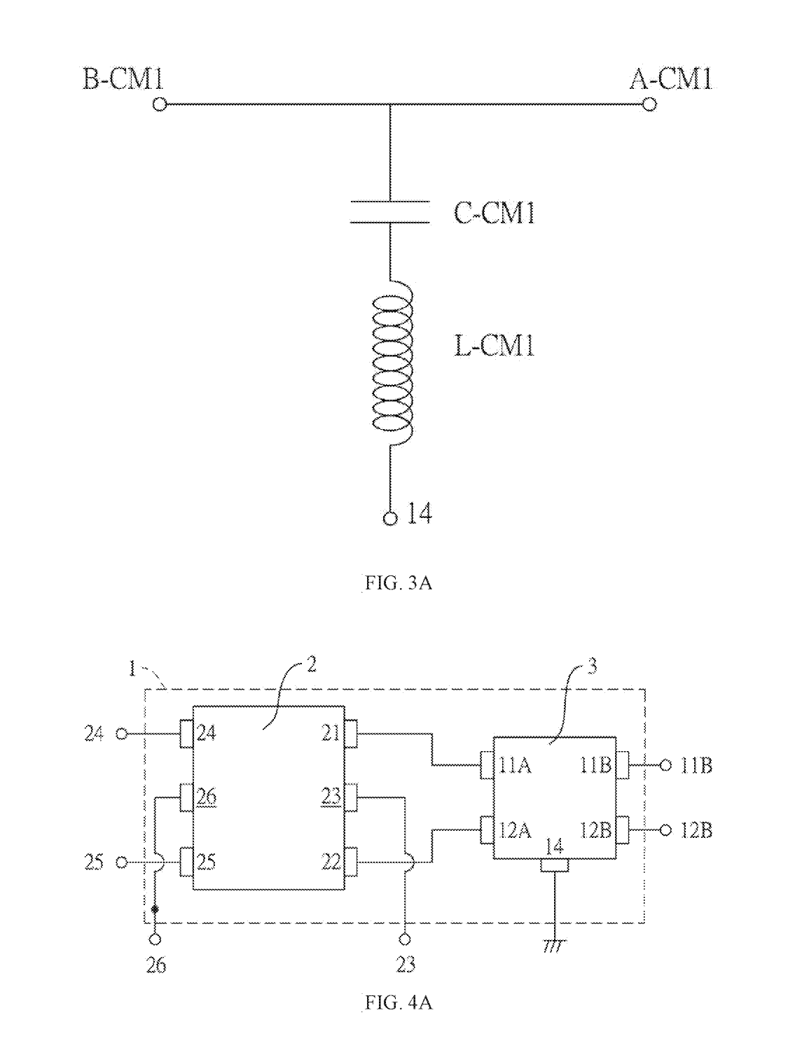

To describe the specific configuration of the circuit structure of this embodiment, reference is made to FIGS. 2 and 3. A first direction X and a second direction Y are defined, and the first direction X is perpendicular to the second direction Y. The first direction X is parallel to the first side edge S1 of the substrate 1, and the second direction Y is parallel to the second side edge S2 of the substrate 1. In this embodiment, as shown in FIG. 3, a bottom of the first dielectric layer D1 of the substrate 1 is disposed on a top of the second dielectric layer D2, and side edges of the second dielectric layer D2 and the first dielectric layer D1 form the first side edge S1 and the second side edge S2. The first conductor 11 and the second conductor 12 are respectively disposed on a top of the first dielectric layer D1. The first segment 13A of the third conductor 13 is disposed on the bottom of the first dielectric layer D1. The first conductive via P1 of the third conductor 13 is disposed within the second dielectric layer D2. The second segment 13B of the third conductor 13 and the reference potential node 14 are respectively disposed on the bottom of the second dielectric layer D2. The first conductive via P1 of the third conductor 13 is electrically connected to the first segment 13A and the second segment 13B of the third conductor 13, and the second segment 13B of the third conductor 13 is electrically connected to the reference potential node 14.

As further shown in FIGS. 2 and 3, the first conductor 11 and the second conductor 12 are disposed on the top of the first dielectric layer D1, and the first segment 13A of the third conductor 13 is disposed on the bottom of the first dielectric layer D1, such that a spacing S is defined between the first conductor 11, the second conductor 12, and the first segment 13A of the third conductor 13. The second segment 13B of the third conductor 13 and the reference potential node 14 are disposed on the bottom of the second dielectric layer D2. The first conductive via P1 of the third conductor 13 extends through the second dielectric layer D2 and is electrically connected to the first segment 13A and the second segment 13B of the third conductor 13. In this embodiment, the transformer 2 may be disposed on the top of the first dielectric layer D1 and adjacent to the first conductor 11 and the second conductor 12.

Regarding a circuit configuration carrying the differential signal in this embodiment, as shown in FIGS. 1 and 2, the first conductor 11 extends along the first direction X and is strip-shaped, and has a first end 11A and a second end 11B opposite to each other along the first direction X. The first end 11A of the first conductor 11 is closer to the transformer 2 than the second end 11B, and the first end 11A is electrically connected to the first pin 21 of the transformer 2 to carry the positive signal (+) of the differential signal. The second conductor 12 extends in a bent manner along the first direction X and the second direction Y and is strip-shaped, and has a first end 12A and a second end 12B opposite to each other along the first direction X. The first end 12A of the second conductor 12 is closer to the transformer 2 than the second end 12B, and the first end 12A is electrically connected to the second pin 22 of the transformer 2 to carry the negative signal (−) of the differential signal. As shown in FIG. 2, no ferrite material is disposed in the first dielectric layer D1, the second dielectric layer D2, or any interlayer therebetween of the substrate 1 of the present disclosure. The common-mode filtering effect of the present disclosure is achieved through routing configurations of the conductors and electromagnetic coupling, rather than by embedding magnetic material into the substrate 1.

Regarding the resonant circuit structure described in this embodiment, when a common-mode noise is introduced into the second end 11B of the first conductor 11 and the second end 12B of the second conductor 12 of the common-mode filtering circuit 3, a common-mode equivalent half-circuit is as shown in FIG. 3A. The resonant circuit structure defines a series LC circuit along a transmission path (node B-CM1 to node A-CM1) of the common-mode noise toward the reference potential node 14, and the series LC circuit is electrically connected to the reference potential node 14 along the transmission path (node B-CM1 to node A-CM1). A fundamental resonant frequency of the resonant circuit structure is affected by a capacitance C-CM1 and an inductance L-CM1, and the fundamental resonant frequency ranges from 30 MHz to 1 GHz. In addition, within a radio-frequency range, considering transmission line effects, at least one of the resonant frequencies of the resonant circuit structure ranges from 1 GHz to 7.2 GHz.

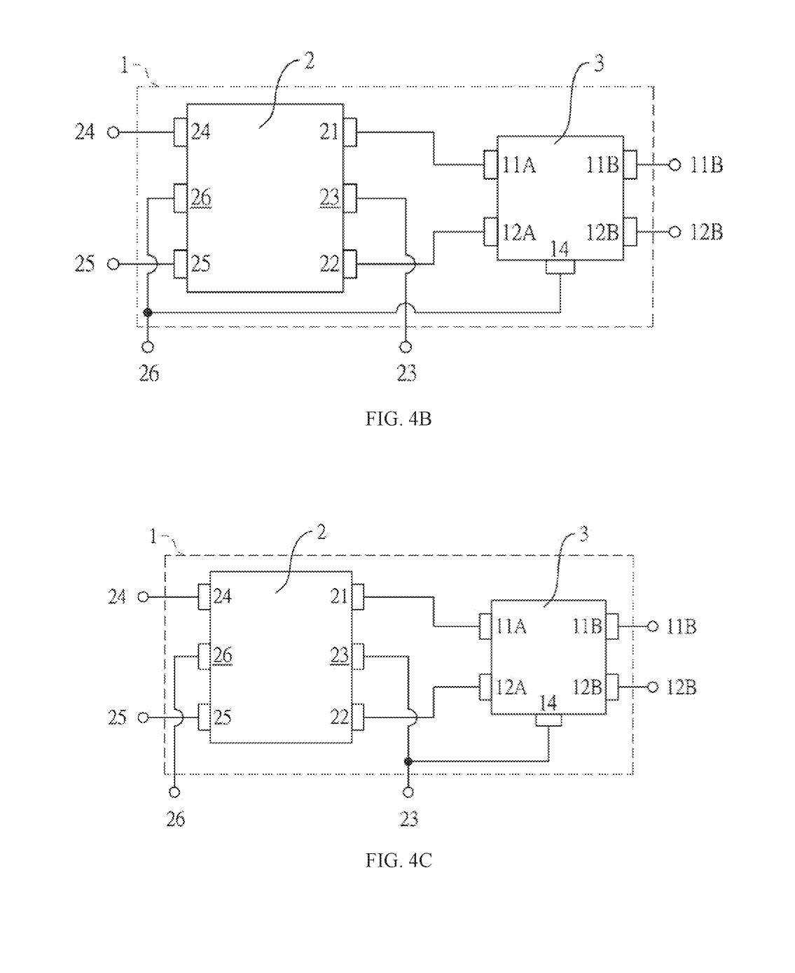

Referring further to FIGS. 4A, 4B and 4C, in this embodiment, the reference potential node 14 may be electrically connected to a system reference potential plane (System GND). Alternatively, the reference potential node 14 may be electrically connected to the first center tap 23 or the second center tap 26 of the transformer 2.

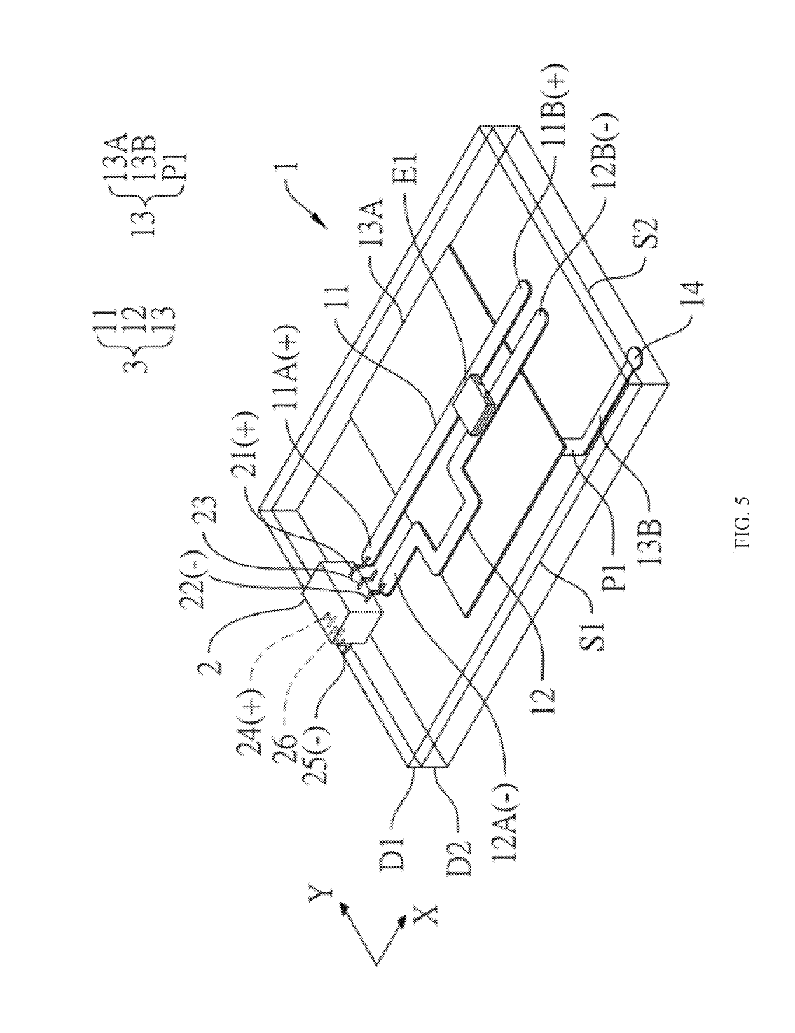

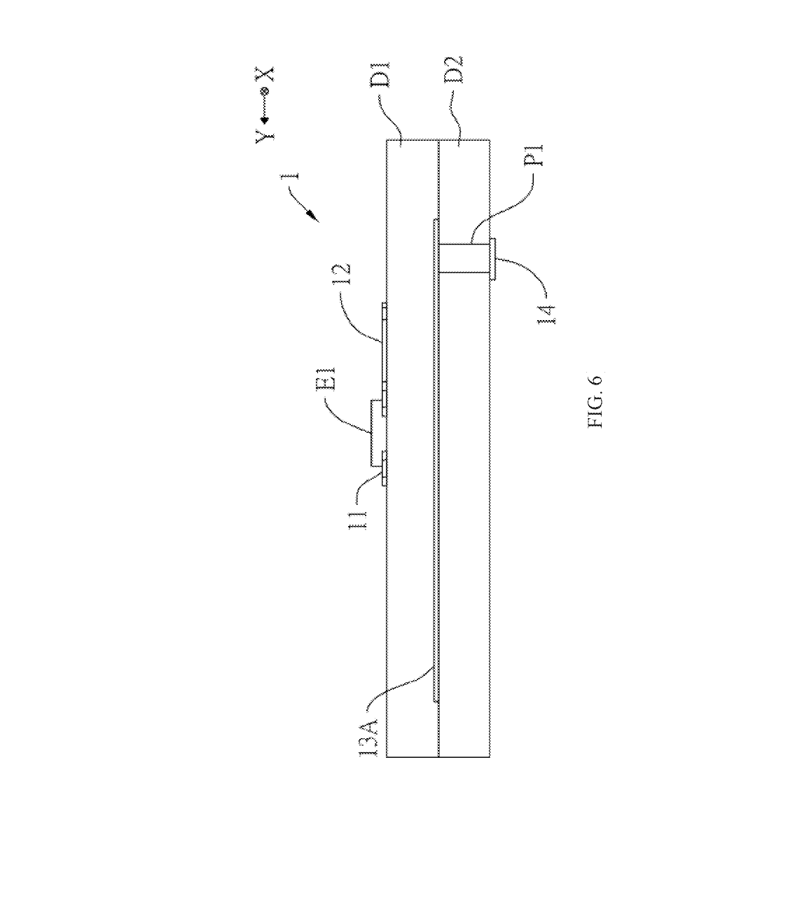

Referring to FIGS. 5 and 6, a second embodiment of the present disclosure is generally similar to the first embodiment (FIGS. 1–4C), except that the substrate 1 of this embodiment further includes a first electronic component E1. In this embodiment, the first electronic component E1 is disposed on the top of the first dielectric layer D1 and is electrically connected between the first conductor 11 and the second conductor 12.

As shown in FIGS. 5 and 6, the first electronic component E1 is disposed on the top of the first dielectric layer D1 and is located between the first conductor 11 and the second conductor 12. The first electronic component E1 has two terminals along the second direction Y, and the two terminals are respectively electrically connected to the first conductor 11 and the second conductor 12 for controlling/adjusting electromagnetic coupling between the first conductor 11 and the second conductor 12. In this embodiment, the first electronic component E1 includes a surface mount device (SMD), which may be a resistor, a capacitor, or an inductor. By adjusting a resistance value, a capacitance value, or an inductance value of the first electronic component E1, electromagnetic coupling between the first conductor 11 and the second conductor 12 can be controlled/adjusted.

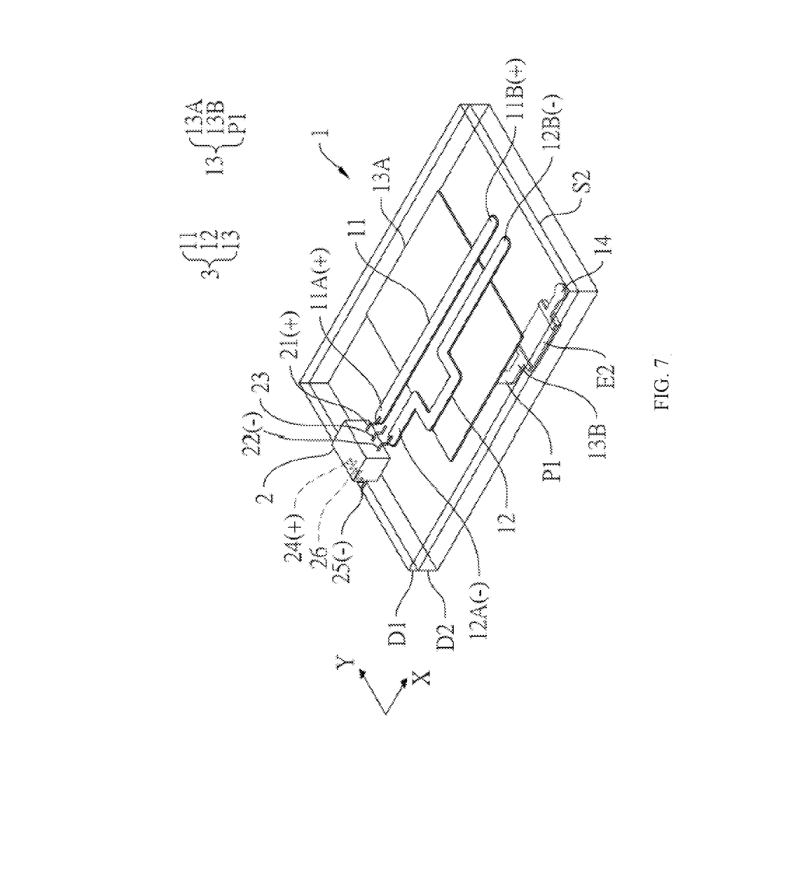

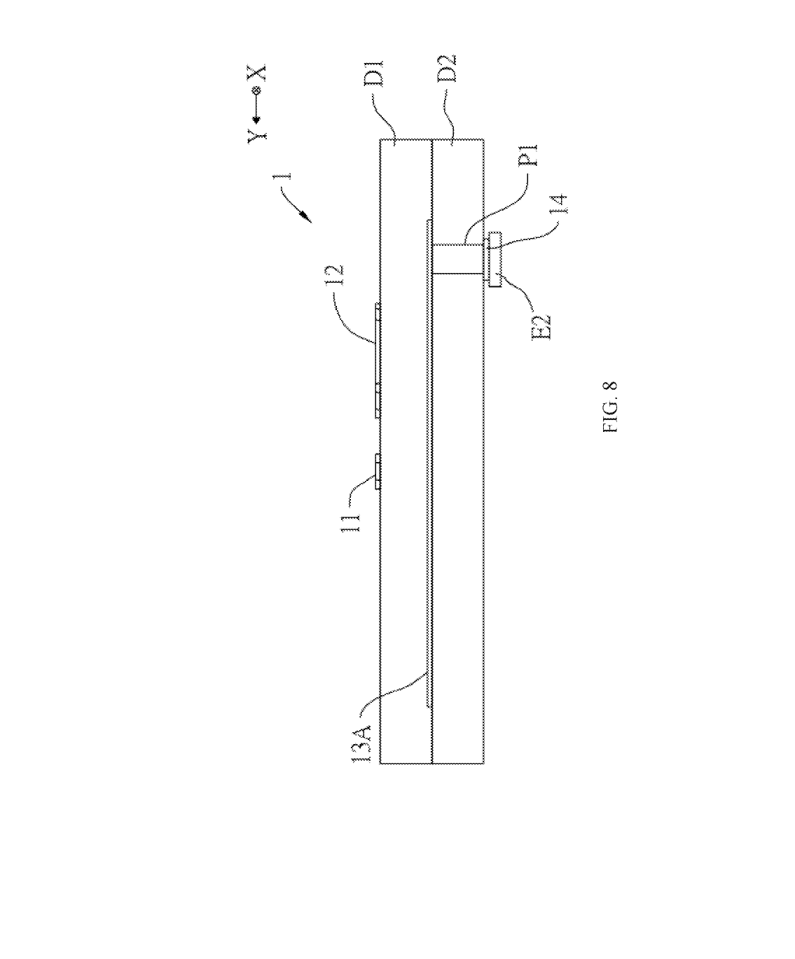

Referring to FIGS. 7 and 8, a third embodiment of the present disclosure is generally similar to the first embodiment (FIGS. 1–4C), except that the substrate 1 of this embodiment further includes a second electronic component E2. In this embodiment, the second electronic component E2 is disposed on the bottom of the second dielectric layer D2 and is electrically connected between the second segment 13B of the third conductor 13 and the reference potential node 14.

As shown in FIGS. 7 and 8, the second electronic component E2 is located between the second segment 13B of the third conductor 13 and the reference potential node 14. The second electronic component E2 has two terminals along the first direction X, and the two terminals are respectively electrically connected to the second segment 13B of the third conductor 13 and the reference potential node 14. In this embodiment, the second electronic component E2 includes a surface mount device (SMD), which may be a resistor, a capacitor, or an inductor. By adjusting a resistance value, a capacitance value, or an inductance value of the second electronic component E2, the above resonant circuit structure can be controlled/adjusted.

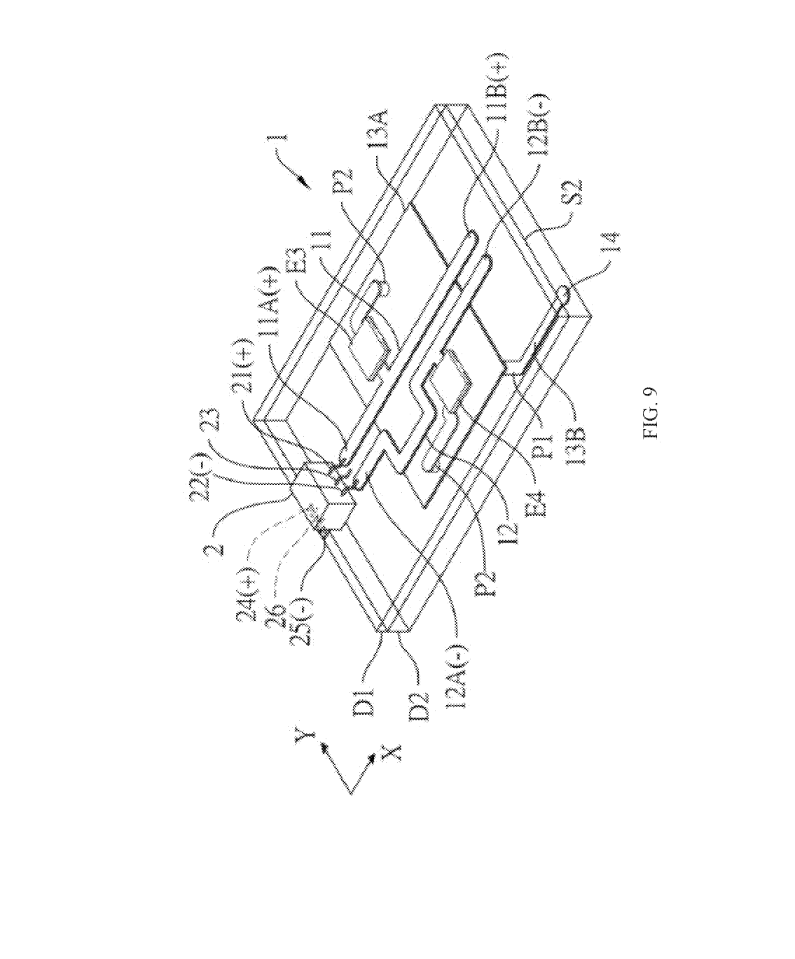

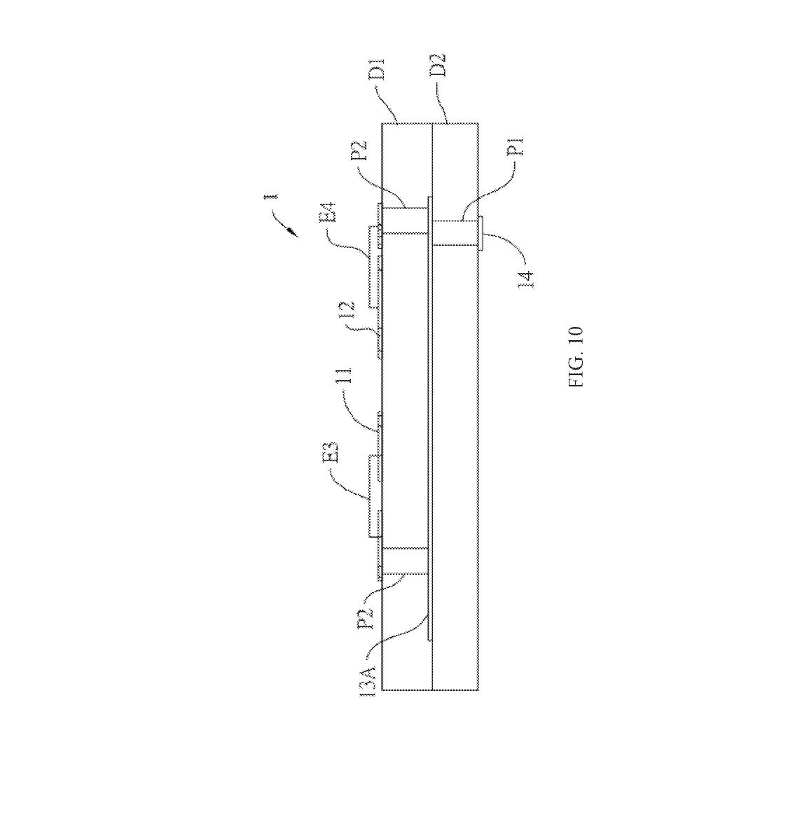

Referring to FIGS. 9 and 10, a fourth embodiment of the present disclosure is generally similar to the first embodiment (FIGS. 1–4C), except that the substrate 1 of this embodiment further includes a third electronic component E3, a fourth electronic component E4, and a plurality of second conductive vias P2. The third electronic component E3 and the fourth electronic component E4 are respectively disposed on the top of the first dielectric layer D1, and the second conductive vias P2 are respectively disposed within the first dielectric layer D1. The third electronic component E3 and the fourth electronic component E4 are respectively electrically connected to the first conductor 11 and the second conductor 12. The second conductive vias P2 are respectively electrically connected to the third electronic component E3, the fourth electronic component E4, and the first segment 13A of the third conductor 13, such that the third electronic component E3 and the second conductive vias P2 are electrically connected between the first conductor 11 and the first segment 13A of the third conductor 13, and such that the fourth electronic component E4 and the second conductive vias P2 are electrically connected between the second conductor 12 and the first segment 13A of the third conductor 13, thereby enhancing electromagnetic coupling between the first conductor 11 and the second conductor 12 and the first segment 13A of the third conductor 13.

As shown in FIGS. 9 and 10, the third electronic component E3 and the fourth electronic component E4 are respectively disposed on the top of the first dielectric layer D1, and each of the third electronic component E3 and the fourth electronic component E4 has two terminals. A terminal of the third electronic component E3 adjacent to the first conductor 11 is connected to the first conductor 11, and a terminal of the fourth electronic component E4 adjacent to the second conductor 12 is connected to the second conductor 12. The second conductive vias P2 extend through the first dielectric layer D1. One second conductive via P2 is electrically connected to the other terminal of the third electronic component E3 and the first segment 13A of the third conductor 13, and another second conductive via P2 is electrically connected to the other terminal of the fourth electronic component E4 and the first segment 13A of the third conductor 13. The third electronic component E3 is configured to control/adjust electromagnetic coupling between the first conductor 11 and the first segment 13A of the third conductor 13, and the fourth electronic component E4 is configured to control/adjust electromagnetic coupling between the second conductor 12 and the first segment 13A of the third conductor 13.

In this embodiment, the third electronic component E3 and the fourth electronic component E4 may respectively be a surface mount device (SMD), which may be a resistor, a capacitor, or an inductor. By adjusting resistance values, capacitance values, or inductance values of the third electronic component E3 and the fourth electronic component E4, electromagnetic coupling between the first conductor 11 and the first segment 13A of the third conductor 13 and electromagnetic coupling between the second conductor 12 and the first segment 13A of the third conductor 13 can be controlled/adjusted.

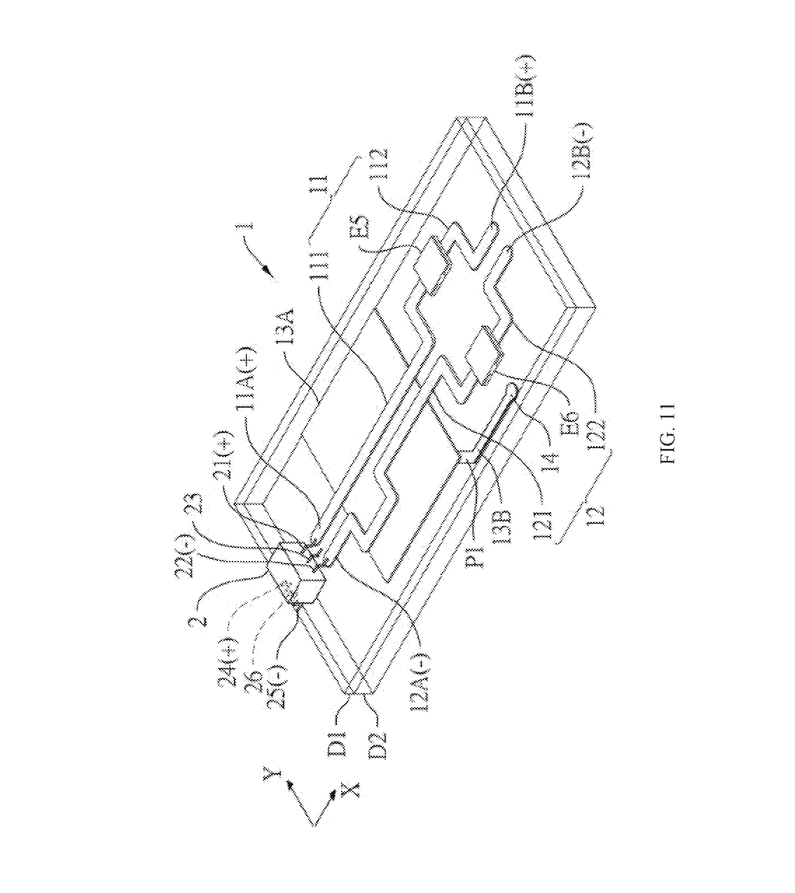

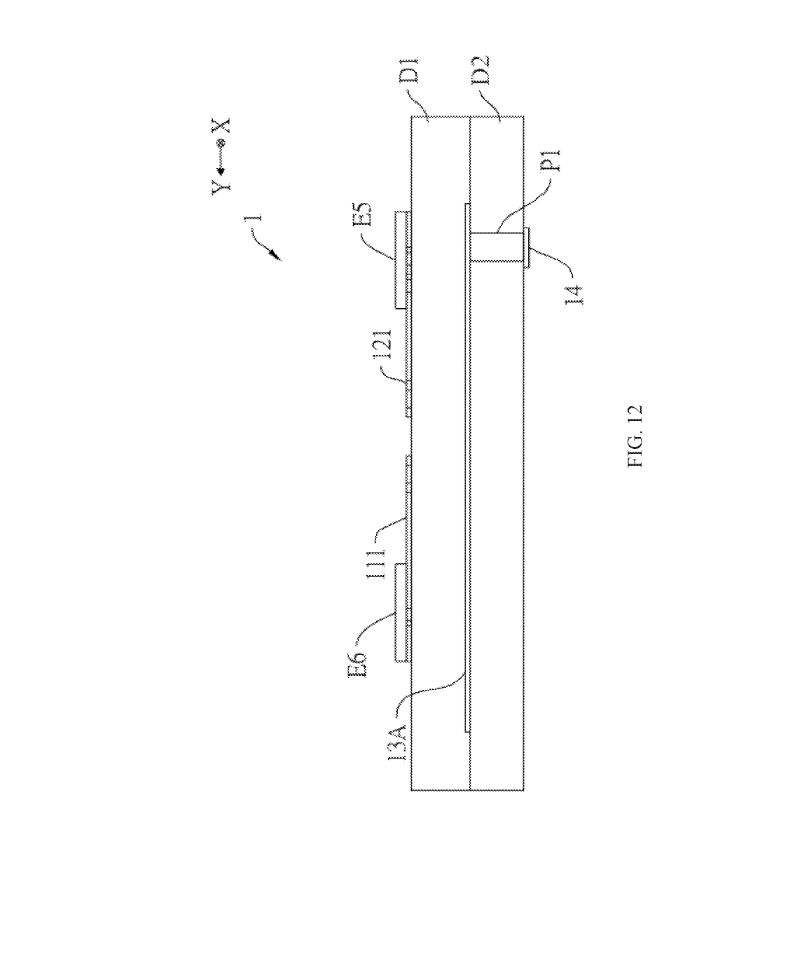

Referring to FIGS. 11 and 12, a fifth embodiment of the present disclosure is generally similar to the first embodiment (FIGS. 1–4C), except that the substrate 1 of this embodiment further includes a fifth electronic component E5 and a sixth electronic component E6. The fifth electronic component E5 and the sixth electronic component E6 may respectively be a surface mount device (SMD), which may be a resistor, a capacitor, an inductor, or an electrostatic discharge (ESD) component.

As shown in FIGS. 11 and 12, the first conductor 11 is divided into a first front segment 111 and a first rear segment 112. The first front segment 111 includes the first end 11A and is electrically connected to the first pin 21 of the transformer 2, and the first rear segment 112 includes the second end 11B. In this embodiment, the fifth electronic component E5 is disposed on the top of the first dielectric layer D1 and is electrically connected between the first front segment 111 and the first rear segment 112 of the first conductor 11. The fifth electronic component E5 has two terminals along the first direction X, and the two terminals are respectively electrically connected to the first front segment 111 and the first rear segment 112. Portions of the first front segment 111 and the first rear segment 112 connected to the fifth electronic component E5 are bent in a C-shape to provide space for placing the fifth electronic component E5.

As shown in FIGS. 11 and 12, the second conductor 12 is divided into a second front segment 121 and a second rear segment 122. The second front segment 121 includes the first end 12A and is electrically connected to the second pin 22 of the transformer 2, and the second rear segment 122 includes the second end 12B. In this embodiment, the sixth electronic component E6 is disposed on the top of the first dielectric layer D1 and is electrically connected between the second front segment 121 and the second rear segment 122 of the second conductor 12. The sixth electronic component E6 has two terminals along the first direction X, and the two terminals are respectively electrically connected to the second front segment 121 and the second rear segment 122. Portions of the second front segment 121 and the second rear segment 122 connected to the sixth electronic component E6 are bent in a C-shape to provide space for placing the sixth electronic component E6.

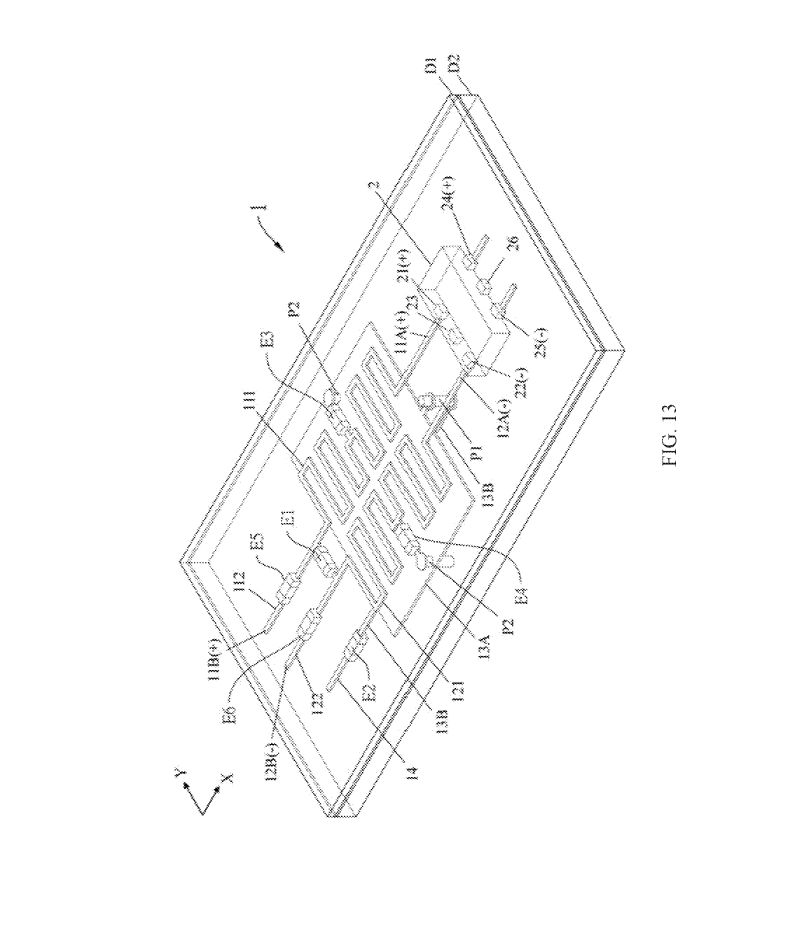

Referring to FIG. 13, a sixth embodiment of the circuit structure for suppressing electromagnetic noise of the present disclosure is generally similar to the above embodiments, except that extension and formation structures of the first conductor 11, the second conductor 12, and the third conductor 13 are different. In this embodiment, the first conductor 11, the second conductor 12, and the third conductor 13 are respectively routed in a meandering manner to form electromagnetic coupling.

As shown in FIG. 13, above the first segment 13A of the third conductor 13, the first front segment 111 of the first conductor 11 and the second front segment 121 of the second conductor 12 extend along the first direction X and the second direction Y through continuous bends to form meandering shapes. Below the first segment 13A of the third conductor 13, a portion of the second segment 13B of the third conductor 13 extends along the first direction X and the second direction Y through continuous bends to form a meandering shape.

In this embodiment, the first electronic component E1 is electrically connected between the first front segment 111 of the first conductor 11 and the second front segment 121 of the second conductor 12. The third electronic component E3 and the second conductive vias P2 are electrically connected between the first front segment 111 of the first conductor 11 and the first segment 13A of the third conductor 13. The fourth electronic component E4 and the second conductive vias P2 are electrically connected between the second front segment 121 of the second conductor 12 and the first segment 13A of the third conductor 13. The fifth electronic component E5 is electrically connected between the first front segment 111 and the first rear segment 112 of the first conductor 11. The sixth electronic component E6 is electrically connected between the second front segment 121 and the second rear segment 122 of the second conductor 12. The second electronic component E2 is electrically connected between the second segment 13B of the third conductor 13 and the reference potential node 14.

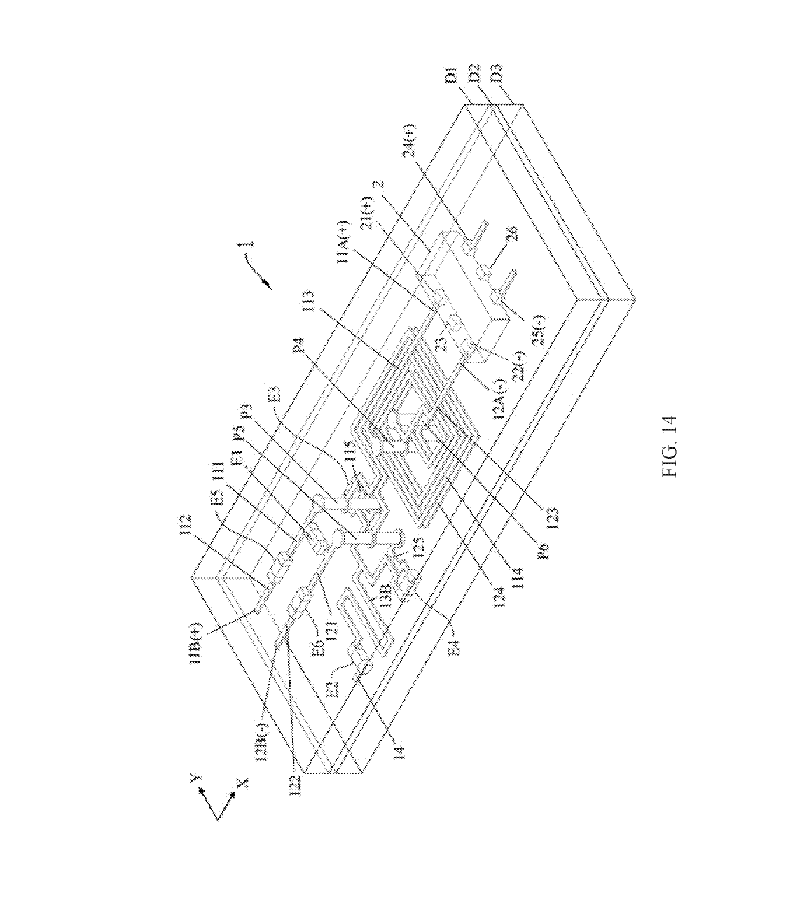

Referring to FIG. 14, a seventh embodiment of the circuit structure for suppressing electromagnetic noise of the present disclosure is generally similar to the sixth embodiment (FIG. 13), except that the first segment 13A and the first conductive via P1 of the third conductor 13 are not provided in the substrate 1 of this embodiment, and the configurations of the first conductor 11, the second conductor 12, and the third conductor 13 are different. In this embodiment, the first conductor 11 and the second conductor 12 are arranged in a planar spiral configuration to form electromagnetic coupling. The substrate 1 further includes a third dielectric layer D3, a top of the third dielectric layer D3 is disposed below a bottom of the second dielectric layer D2, and the second segment 13B of the third conductor 13 and the reference potential node 14 are respectively disposed on a bottom of the third dielectric layer D3.

To further describe a specific configuration in which the first conductor 11 and the second conductor 12 are arranged in a planar spiral configuration, as shown in FIG. 14, the first conductor 11 further includes a strip-shaped first upper connecting segment 113, a first spiral segment 114, and a strip-shaped first lower connecting segment 115. The first front segment 111 is electrically connected to the first spiral segment 114 and the first lower connecting segment 115 through a third conductive via P3. The first spiral segment 114 is electrically connected to the first upper connecting segment 113 through a fourth conductive via P4. The second conductor 12 further includes a strip-shaped second upper connecting segment 123, a second spiral segment 124, and a strip-shaped second lower connecting segment 125. The second front segment 121 is electrically connected to the second spiral segment 124 and the second lower connecting segment 125 through a fifth conductive via P5. The second spiral segment 124 is electrically connected to the second upper connecting segment 123 through a sixth conductive via P6.

The first upper connecting segment 113 and the second upper connecting segment 123, together with the first front segment 111, the first rear segment 112, the second front segment 121, the second rear segment 122, the first electronic component E1, the fifth electronic component E5, and the sixth electronic component E6, are disposed on the top of the first dielectric layer D1. One end of the first upper connecting segment 113 and one end of the second upper connecting segment 123 respectively form the first end 11A of the first conductor 11 and the first end 12A of the second conductor 12, and are respectively electrically connected to the first pin 21 and the second pin 22 of the transformer 2 to respectively carry the positive signal (+) and the negative signal (−) of the differential signal.

The first spiral segment 114 is disposed on the top of the second dielectric layer D2, and the second spiral segment 124 is disposed on the top of the third dielectric layer D3. The first spiral segment 114 and the second spiral segment 124 are routed in a spiral manner within planes defined by the first direction X and the second direction Y. In this embodiment, each of the first spiral segment 114 and the second spiral segment 124 has a square spiral shape, and the first spiral segment 114 and the second spiral segment 124 overlap each other to form an overlapping planar spiral configuration, but are not limited thereto.

The first lower connecting segment 115 and the second lower connecting segment 125, together with the second electronic component E2, the third electronic component E3, the fourth electronic component E4, the second segment 13B of the third conductor 13, and the reference potential node 14, are disposed on the bottom of the third dielectric layer D3. The third electronic component E3 is electrically connected between the first lower connecting segment 115 and the second segment 13B of the third conductor 13. The fourth electronic component E4 is electrically connected between the second lower connecting segment 125 and the second segment 13B of the third conductor 13. The second electronic component E2 is electrically connected between the second segment 13B of the third conductor 13 and the reference potential node 14.

Accordingly, by routing the first spiral segment 114 of the first conductor 11 and the second spiral segment 124 of the second conductor 12 are in a spiral manner, when a common-mode current flows through the first conductor 11 and the second conductor 12, magnetic flux directions formed by the first conductor 11 and the second conductor 12 are the same, thereby increasing electromagnetic coupling between the first conductor 11 and the second conductor 12 such that a magnetic coupling coefficient between the first conductor 11 and the second conductor 12 is greater than 0.3, thereby suppressing propagation of common-mode noise carried by the first conductor 11 and the second conductor 12.

Further, the first conductor 11, the second conductor 12, and the third conductor 13 of the substrate 1 form the common-mode filtering circuit 3, and the first conductor 11 and the second conductor 12 are connected to the first pin 21 and the second pin 22 of the transformer 2 to respectively carry the positive signal (+) and the negative signal (−) of the differential signal. The third conductor 13 is electromagnetically coupled to the first conductor 11 and the second conductor 12 through the third electronic component E3 and the fourth electronic component E4, thereby suppressing propagation of common-mode noise carried by the first conductor 11 and the second conductor 12. With such a structural improvement, the common-mode filtering circuit is more easily integrated into the substrate, thereby saving space and improving substrate space utilization.

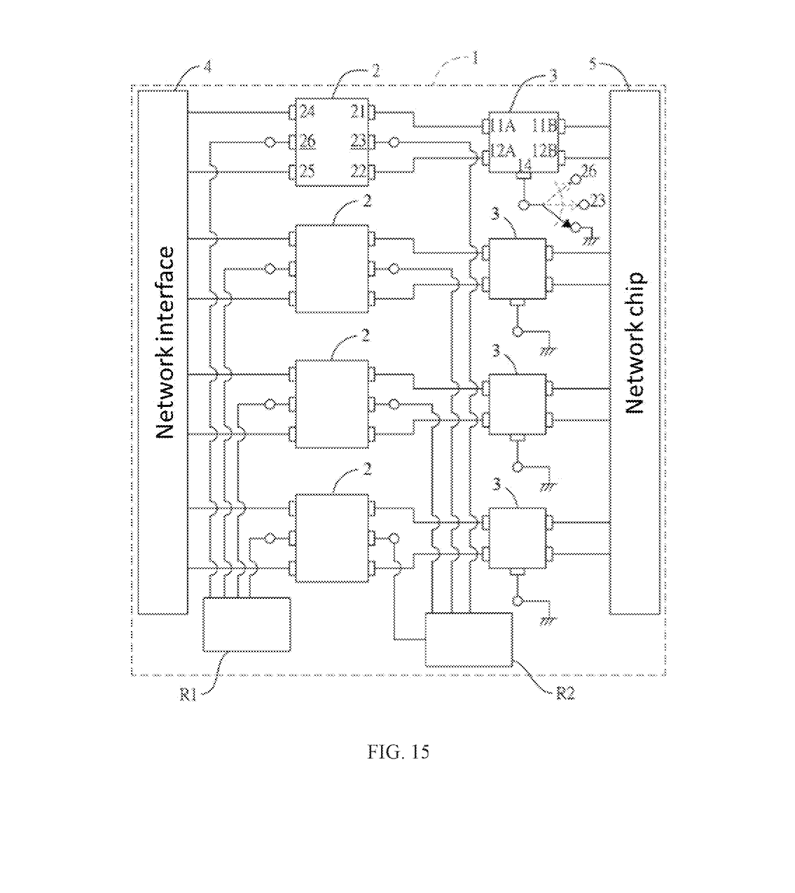

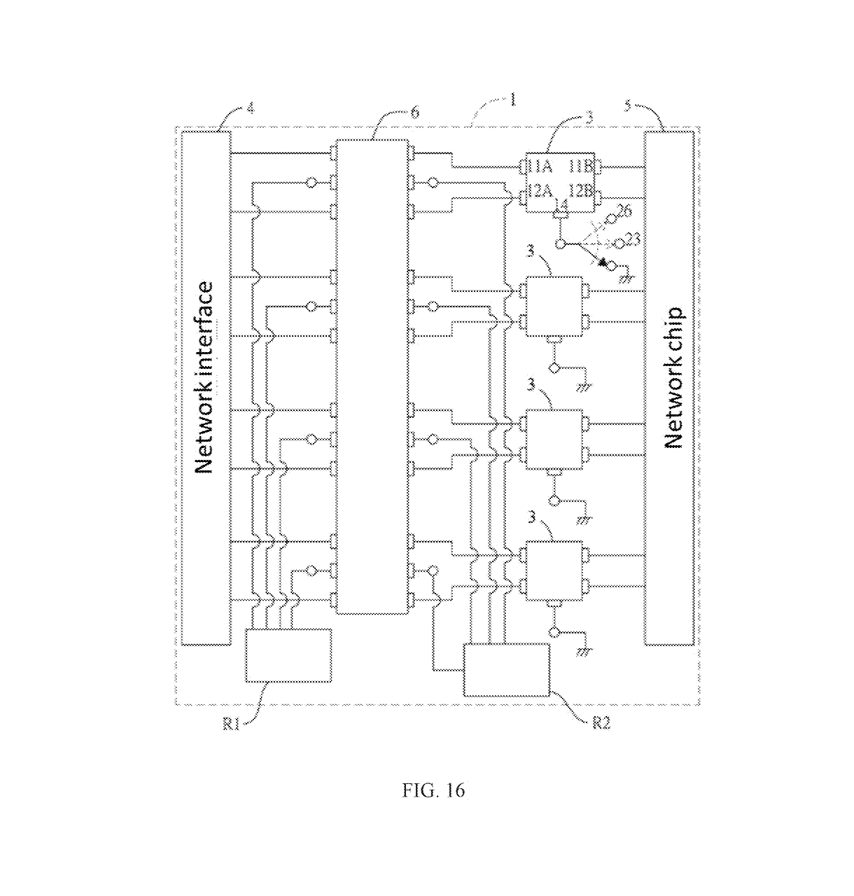

Referring to FIGS. 15 and 16, an eighth embodiment and a ninth embodiment of the circuit structure for suppressing electromagnetic noise of the present disclosure are generally similar to the above embodiments, except that the eighth and ninth embodiments further include a network interface 4, a network chip 5, a first peripheral circuit R1, and a second peripheral circuit R2. The network interface 4, the network chip 5, the first peripheral circuit R1, and the second peripheral circuit R2 are respectively disposed on the substrate 1. As shown in FIGS. 15 and 16, in the eighth and ninth embodiments, the network interface 4, the first peripheral circuit R1, and the second peripheral circuit R2 may be electrically connected to the transformer 2, and the network chip 5 is electrically connected to the common-mode filtering circuit 3. The network chip 5 transmits a network signal, and the network signal sequentially passes through the common-mode filtering circuit 3, the transformer 2, and the network interface 4.

In the eighth and ninth embodiments, the network interface 4 includes an RJ45 interface or an optical module interface (e.g., a small form-factor pluggable (SFP) interface). The network chip 5 may be a chip for input/output of an IEEE 802.3 Ethernet physical layer signal. The first peripheral circuit R1 may be a Bob Smith circuit. The second peripheral circuit R2 may be a driver circuit of the network chip 5, which may be a voltage-mode driver or a current-mode driver. Since the first peripheral circuit R1 and the second peripheral circuit R2 are common and well-known, details thereof are not repeated herein.

Referring first to FIG. 15, in the eighth embodiment, a plurality of transformers 2 and a plurality of common-mode filtering circuits 3 are each provided. The network interface 4 is respectively electrically connected to the third pins 24 and the fourth pins 25 of the transformers 2. The first pins 21 and the second pins 22 of the transformers 2 are respectively electrically connected to the first ends 11A of the first conductors 11 and the first ends 12A of the second conductors 12 of the common-mode filtering circuits 3. The network chip 5 is respectively electrically connected to the second ends 11B of the first conductors 11 and the second ends 12B of the second conductors 12 of the common-mode filtering circuits 3 to transmit positive signals (+) and negative signals (−) of a plurality of differential signals. The second center taps 26 of the transformers 2 are respectively electrically connected to the first peripheral circuit R1, and the first center taps 23 of the transformers 2 are respectively electrically connected to the second peripheral circuit R2. As described above, the reference potential nodes 14 of the common-mode filtering circuits 3 may be respectively electrically connected to the first center taps 23, the second center taps 26, or a system ground plane (System GND). FIG. 15 illustrates an example in which the reference potential nodes 14 are respectively electrically connected to the system ground plane.

Referring to FIG. 16, in the ninth embodiment, the technical content is generally similar to that of the eighth embodiment, except that the transformers 2 are formed as an integrated transformer 6 through packaging technology. The integrated transformer 6 is electrically connected to the network interface 4, the first ends 11A of the first conductors 11, and the first ends 12A of the second conductors 12.

In other embodiments, a relative arrangement order of the transformer 2 and the common-mode filtering circuit 3 may be interchanged such that the network interface 4 is electrically connected to the common-mode filtering circuit 3, and the network chip 5, the first peripheral circuit R1, and the second peripheral circuit R2 are electrically connected to the transformer 2. In such embodiments, the network chip 5 transmits a network signal, and the network signal sequentially passes through the transformer 2, the common-mode filtering circuit 3, and the network interface 4.

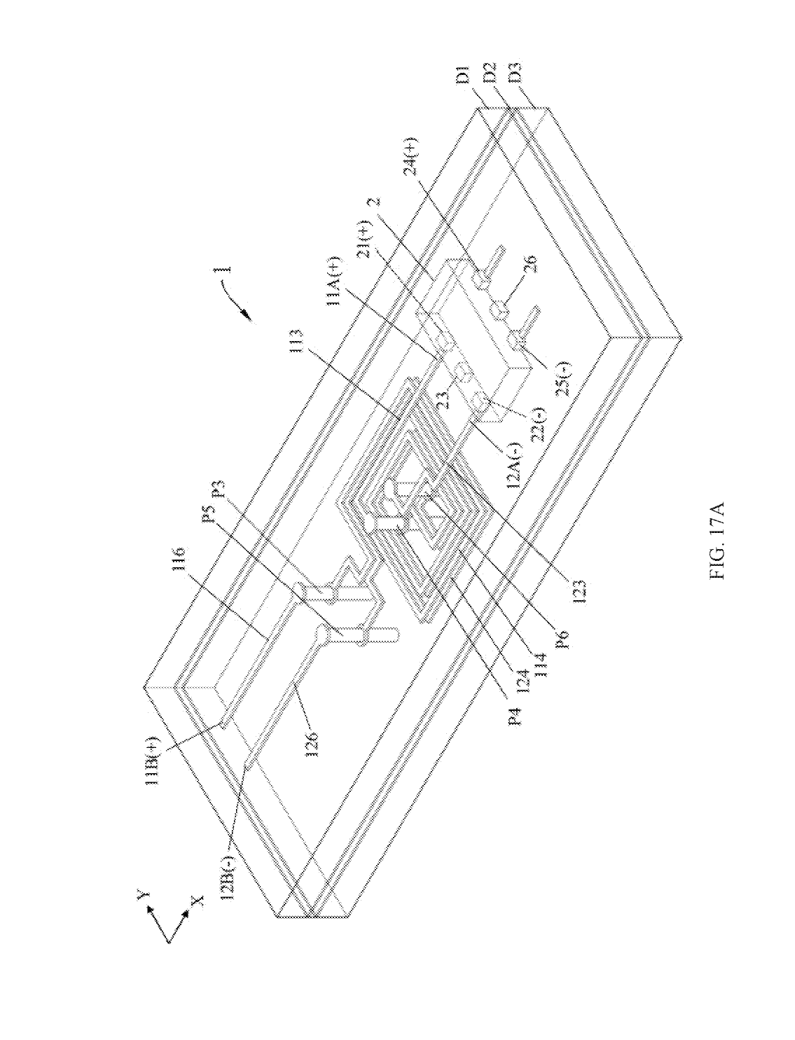

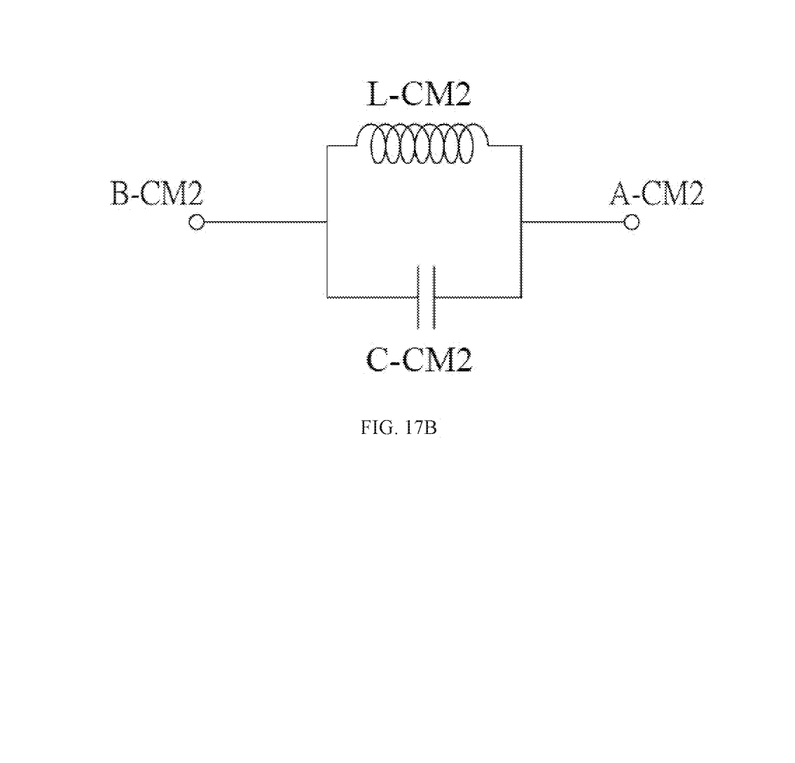

Referring to FIG. 17A, a tenth embodiment of the circuit structure for suppressing electromagnetic noise of the present disclosure is generally similar to the seventh embodiment (FIG. 14), except that the substrate 1 of this embodiment does not include the first electronic component E1, the second electronic component E2, the third electronic component E3, the fourth electronic component E4, the fifth electronic component E5, the sixth electronic component E6, the third conductor 13, or the reference potential node 14, and configurations of the first conductor 11 and the second conductor 12 are also slightly different.

As shown in FIG. 17A, the first conductor 11 includes the first upper connecting segment 113, the first spiral segment 114, and a strip-shaped third upper connecting segment 116. The second conductor 12 includes the second upper connecting segment 123, the second spiral segment 124, and a strip-shaped fourth upper connecting segment 126. The third upper connecting segment 116 and the fourth upper connecting segment 126 are disposed on the top of the first dielectric layer D1 together with the first upper connecting segment 113 and the second upper connecting segment 123. One end of the third upper connecting segment 116 and one end of the fourth upper connecting segment 126 respectively form the second end 11B of the first conductor 11 and the second end 12B of the second conductor 12 for introducing a differential signal.

In this embodiment, the substrate 1 includes a third conductive via P3, a fourth conductive via P4, a fifth conductive via P5, and a sixth conductive via P6. The third conductive via P3, the fourth conductive via P4, the fifth conductive via P5, and the sixth conductive via P6 respectively extend through the first dielectric layer D1, the second dielectric layer D2, and the third dielectric layer D3. The third conductive via P3 is electrically connected to the third upper connecting segment 116 and the first spiral segment 114. The fourth conductive via P4 is electrically connected to the first upper connecting segment 113 and the first spiral segment 114. The fifth conductive via P5 is electrically connected to the fourth upper connecting segment 126 and the second spiral segment 124. The sixth conductive via P6 is electrically connected to the second upper connecting segment 123 and the second spiral segment 124. The first conductor 11 and the second conductor 12 are arranged in a planar spiral configuration to form electromagnetic coupling. In addition, the first spiral segment 114 is disposed on a top of the second dielectric layer D2, and the second spiral segment 124 is disposed on a top of the third dielectric layer D3. The first spiral segment 114 and the second spiral segment 124 are routed in a spiral manner within planes defined by the first direction X and the second direction Y. In this embodiment, each of the first spiral segment 114 and the second spiral segment 124 has a square spiral shape, and the first spiral segment 114 and the second spiral segment 124 overlap each other to form an overlapping planar spiral configuration, but are not limited thereto. Accordingly, when a common-mode current flows through the first conductor 11 and the second conductor 12, magnetic flux directions formed by the first conductor 11 and the second conductor 12 are the same, thereby increasing electromagnetic coupling so as to suppress propagation of common-mode noise.

The first upper connecting segment 113 and the second upper connecting segment 123 respectively carry the positive signal (+) and the negative signal (−) of the differential signal. When a common-mode noise is introduced into the second end 11B of the first conductor 11 and the second end 12B of the second conductor 12, a magnetic coupling coefficient between the first conductor 11 and the second conductor 12 is greater than 0.3 such that a resonant circuit structure is formed.

The first conductor 11 and the second conductor 12 of the substrate 1 form the common-mode filtering circuit 3, and the first conductor 11 and the second conductor 12 are electrically connected to the first pin 21 and the second pin 22 of the transformer 2 to respectively carry the positive signal (+) and the negative signal (−) of the differential signal. When the common-mode noise is introduced into the first conductor 11 and the second conductor 12, the magnetic coupling coefficient between the first conductor 11 and the second conductor 12 is greater than 0.3 such that the resonant circuit structure is formed to suppress propagation of common-mode noise carried by the first conductor 11 and the second conductor 12. By improving the circuit structure of the present disclosure, the common-mode filtering circuit is implemented on the substrate to replace a conventional common-mode choke, thereby reducing the number of magnetic cores and windings required in the transformer and the common-mode filtering circuit, achieving reduced package volume and improved substrate space utilization, and enhancing process stability and yield.

Regarding the resonant circuit structure described in this embodiment, when the common-mode noise is introduced into the second end 11B of the first conductor 11 and the second end 12B of the second conductor 12 of the common-mode filtering circuit 3, a common-mode equivalent half-circuit is as shown in FIG. 17B. The resonant circuit structure defines a parallel LC circuit along a transmission path (node B-CM2 to node A-CM2) of the common-mode noise, and the parallel LC circuit is electrically connected along the transmission path (node B-CM2 to node A-CM2). A fundamental resonant frequency of the resonant circuit structure is affected by a capacitance C-CM2 and an inductance L-CM2, and the fundamental resonant frequency ranges from 30 MHz to 1 GHz. In addition, within a radio-frequency range, considering transmission line effects, at least one of the resonant frequencies of the resonant circuit structure ranges from 1 GHz to 7.2 GHz.

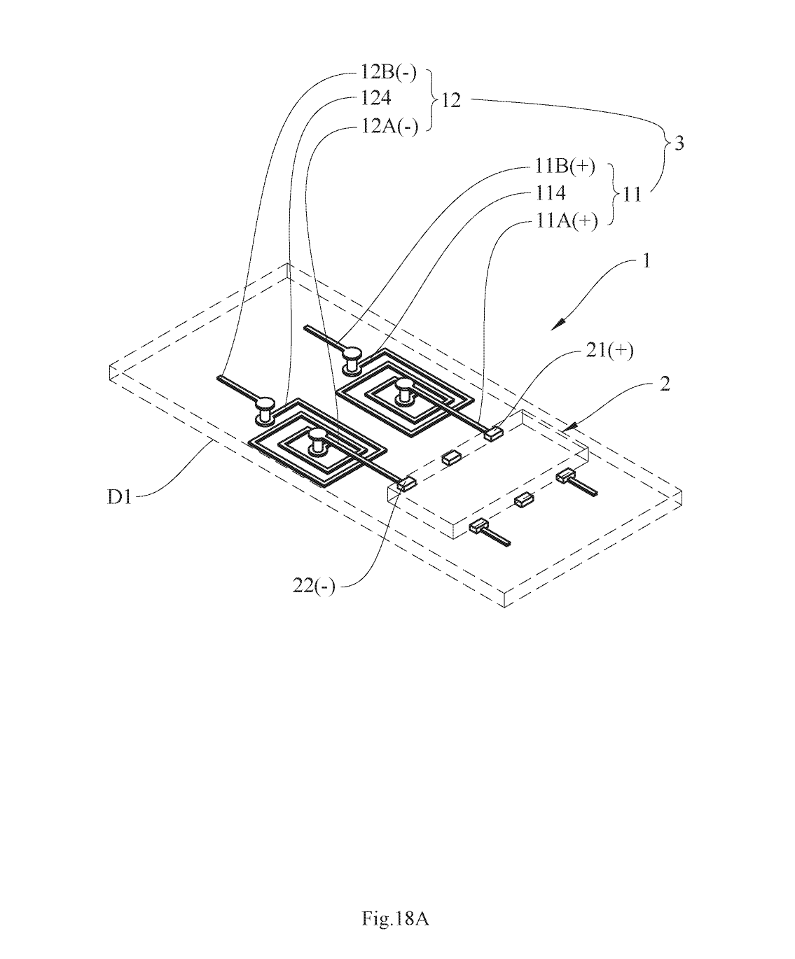

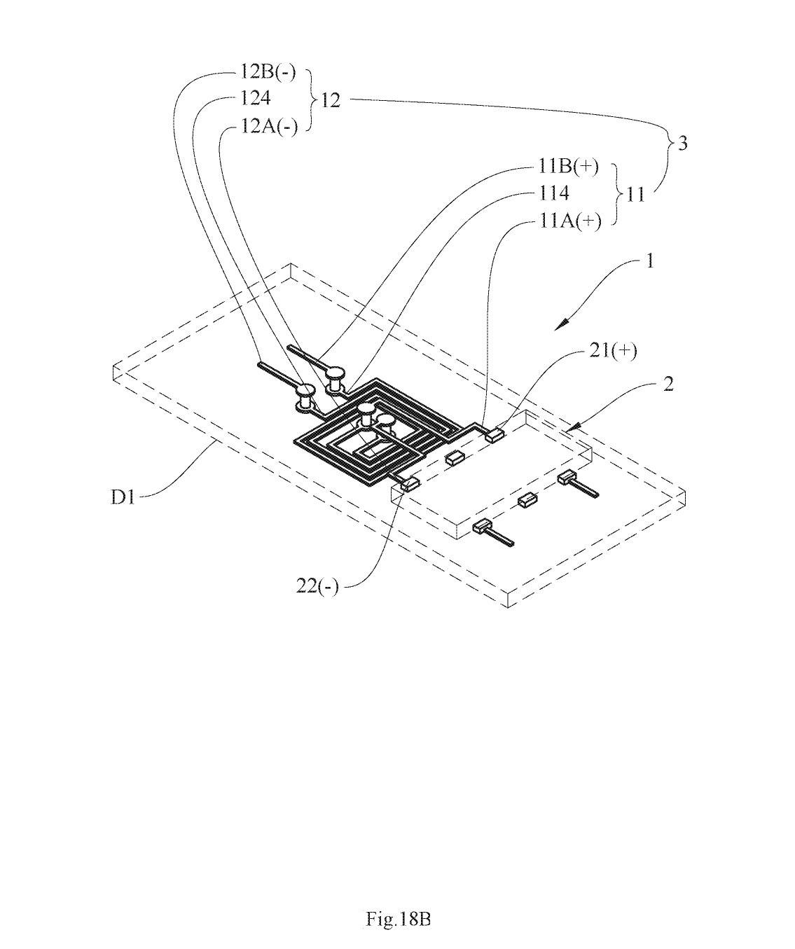

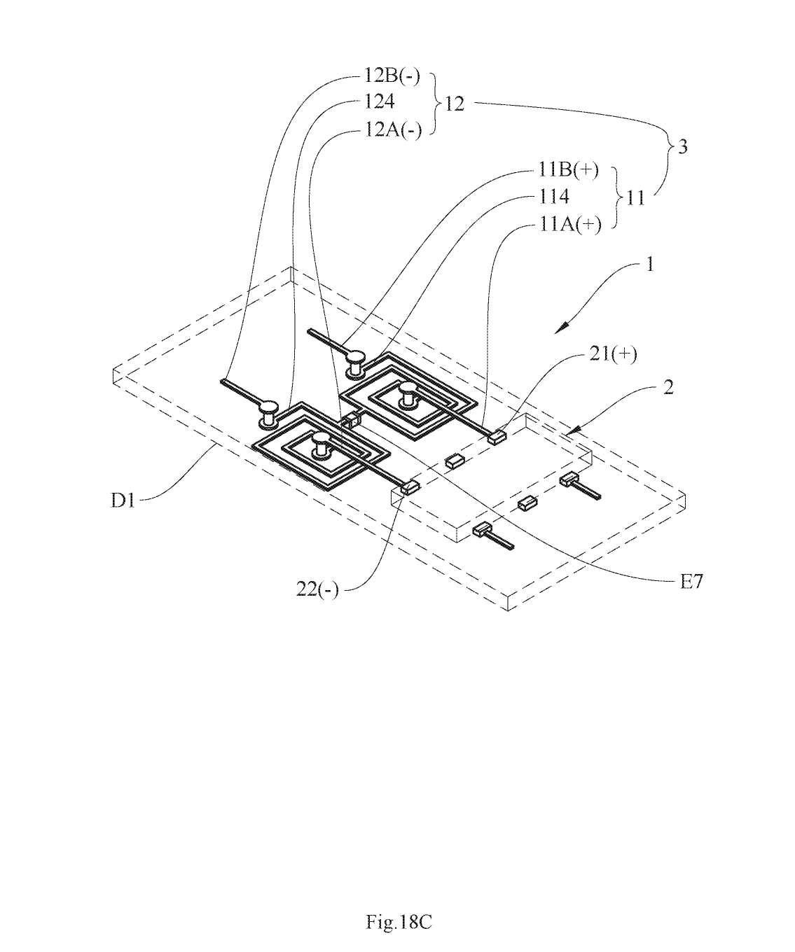

Referring to FIGS. 18A and 18B, an eleventh embodiment of the circuit structure for suppressing electromagnetic noise of the present disclosure is shown. In this embodiment, the first spiral segment 114 of the first conductor 11 and the second spiral segment 124 of the second conductor 12 are routed in the substrate 1 in a spiral manner within planes defined by the first direction X and the second direction Y. The first conductor 11 and the second conductor 12 of the substrate 1 form the common-mode filtering circuit 3, and the first end 11A of the first conductor 11 and the first end 12A of the second conductor 12 are electrically connected to the first pin 21 and the second pin 22 of the transformer 2 to respectively carry the positive signal (+) and the negative signal (−) of the differential signal. The first end 11A of the first conductor 11 is closer to the transformer 2 than the second end 11B. The first end 12A of the second conductor 12 is closer to the transformer 2 than the second end 12B. The common-mode filtering circuit 3 does not comprise a magnetic core. The first spiral segment 114 and the second spiral segment 124 are not limited to the square spiral shape shown in FIGS. 14 and 17A, and may also have a circular spiral shape or any other spiral shapes. Moreover, although in FIGS. 14 and 17A, the first spiral segment 114 and the second spiral segment 124 overlap each other to form an overlapping planar spiral configuration, the first spiral segment 114 and the second spiral segment 124 may also have different relative positions in the substrate 1 to provide different degrees of electromagnetic coupling. For example, the planar spiral configuration may be a parallel planar spiral configuration as shown in FIG. 18A or an interleaved planar spiral configuration as shown in FIG. 18B.configuration.When the common-mode noise is introduced into the first conductor 11 and the second conductor 12 of the common-mode filtering circuit 3, the common-mode filtering circuit 3 may define a parallel LC circuit along a transmission path of the common-mode noise. The L of the parallel LC circuit is mainly contributed by the magnetic coupling between the first spiral segment 114 of the first conductor 11 and the second spiral segment 124 of the second conductor 12. By using the interleaved planar spiral configuration shown in FIG. 18B, the magnetic coupling between the first conductor 11 and the second conductor 12 can be further enhanced, so as to increase the magnetic coupling coefficient to be greater than 0.3. A fundamental resonant frequency of the common-mode filtering circuit 3 ranges from 30 MHz to 1 GHz. In addition, within a radio-frequency range, considering transmission line effects, at least one of the resonant frequencies of the common-mode filtering circuit 3 ranges from 1 GHz to 7.2 GHz.

Referring to FIGS. 18A and 18C, the eleventh embodiment of the circuit structure for suppressing electromagnetic noise of the present disclosure. The structure shown in FIGS. 18A further includes a seventh electronic component E7, thereby forming the structure shown in FIG. 18C. The seventh electronic component E7 is disposed on the bottom of the first dielectric layer D1 and has two terminals are respectively electrically connected between the first spiral segment 114 of the first conductor 11 and the second spiral segment 124 of the second conductor 12. In this embodiment, the seventh electronic component E7 includes a surface mount device (SMD), which may be a resistor, a capacitor, or an inductor. By adjusting a resistance value, a capacitance value, or an inductance value of the seventh electronic component E7, electromagnetic coupling between the first spiral segment 114 and the second spiral segment 124 can be controlled/adjusted.

What is claimed is:

1. A circuit structure for suppressing electromagnetic noise, comprising:
a substrate including a first conductor, a second conductor, a third conductor, and a reference potential node, wherein the first conductor, the second conductor, and the third conductor form a common-mode filtering circuit; and
a transformer disposed on the substrate and electrically connected to the first conductor and the second conductor;
wherein the first conductor carries a positive signal of a differential signal and the second conductor carries a negative signal of the differential signal;
wherein the third conductor is electromagnetically coupled to the first conductor and the second conductor;
wherein the third conductor is electrically connected to the reference potential node to form a resonant circuit structure.

2. The circuit structure of claim 1, wherein the transformer comprises a magnetic core and at least two windings disposed on the magnetic core.

3. The circuit structure of claim 1, wherein when a common-mode noise is introduced into the first conductor and the second conductor, the resonant circuit structure defines a series LC circuit along a transmission path of the common-mode noise toward the reference potential node.

4. The circuit structure of claim 1, wherein a fundamental resonant frequency of the resonant circuit structure ranges from 30 MHz to 1 GHz.

5. The circuit structure of claim 1, wherein at least one of the resonant frequencies of the resonant circuit structure ranges from 1 GHz to 7.2 GHz.

6. The circuit structure of claim 1, wherein the common-mode filtering circuit further comprises a first electronic component, the first electronic component having two terminals and electrically connected between the first conductor and the second conductor.

7. The circuit structure of claim 1, wherein the common-mode filtering circuit further comprises a second electronic component, the second electronic component having two terminals and electrically connected between the third conductor and the reference potential node.

8. The circuit structure of claim 1, further comprising a third electronic component and a fourth electronic component configured to enhance the electromagnetic coupling;
the third electronic component having two terminals and electrically connected between the first conductor and the third conductor;
the fourth electronic component having two terminals and electrically connected between the second conductor and the third conductor.

9. The circuit structure of claim 1, wherein the first conductor comprises two segments and the common-mode filtering circuit further comprises a fifth electronic component, the fifth electronic component having two terminals and electrically connected between the two segments of the first conductor.

10. The circuit structure of claim 1, wherein the second conductor comprises two segments and the common-mode filtering circuit further comprises a sixth electronic component, the sixth electronic component having two terminals and electrically connected between the two segments of the second conductor.

11. The circuit structure of claim 1, wherein the first conductor and the second conductor are arranged in a planar spiral configuration to form electromagnetic coupling.

12. The circuit structure of claim 11, wherein the first conductor and the second conductor have a magnetic coupling coefficient greater than 0.3.

13. The circuit structure of claim 1, wherein the first conductor and the second conductor of the common-mode filtering circuit are arranged in a meandering configuration.

14. The circuit structure of claim 1, wherein the third conductor of the common-mode filtering circuit is arranged in a meandering configuration.

15. The circuit structure of claim 1, further comprising a network interface and a network chip;
the network interface disposed on the substrate and the network chip disposed on the substrate;
wherein the network chip transmits a network signal and the network signal sequentially passes through the common-mode filtering circuit, the transformer, and the network interface.

16. The circuit structure of claim 1, further comprising a network interface and a network chip;
the network interface disposed on the substrate and the network chip disposed on the substrate;
wherein the network chip transmits a network signal and the network signal sequentially passes through the transformer, the common-mode filtering circuit, and the network interface.

17. The circuit structure of claim 1, wherein a plurality of transformers and a plurality of common-mode filtering circuits are provided.

18. The circuit structure of claim 17, wherein the plurality of transformers are integrated into an integrated transformer.

19. The circuit structure of claim 1, wherein the substrate is a printed circuit board or a ceramic substrate.

20. A circuit structure for suppressing electromagnetic noise, comprising:
a substrate including a first conductor and a second conductor, the first conductor and the second conductor forming a common-mode filtering circuit; and
a transformer disposed on the substrate and electrically connected to the first conductor and the second conductor;
wherein the first conductor carries a positive signal of a differential signal and the second conductor carries a negative signal of the differential signal; and wherein when a common-mode noise is introduced into the first conductor and the second conductor, a magnetic coupling coefficient between the first conductor and the second conductor is greater than 0.3 such that a resonant circuit structure is formed.

21. The circuit structure of claim 20, wherein when the common-mode noise is introduced into the first conductor and the second conductor, the resonant circuit structure defines a parallel LC circuit along a transmission path of the common-mode noise.

22. A circuit structure for suppressing electromagnetic noise, comprising:
a substrate including a first conductor and a second conductor, the first conductor and the second conductor disposed in the substrate are arranged in a planar spiral configuration and form a common-mode filtering circuit, the common-mode filtering circuit does not comprise a magnetic core; and
a transformer disposed on the substrate and electrically connected to the first conductor and the second conductor;
wherein the first conductor carries a positive signal of a differential signal and the second conductor carries a negative signal of the differential signal; and wherein when a common-mode noise is introduced into the first conductor and the second conductor, the common-mode filtering circuit defines a parallel LC circuit along a transmission path of the common-mode noise; a fundamental resonant frequency of the common-mode filtering circuit ranges from 30 MHz to 1 GHz.

23. The circuit structure of claim 22, wherein the first conductor and the second conductor have a magnetic coupling coefficient greater than 0.3.

24. The circuit structure of claim 22, wherein the common-mode filtering circuit further comprises a seventh electronic component, the seventh electronic component electrically connected between the first conductor and the second conductor.
